(19) United States
(12) Patent Application Publication
(10) Pub. No.: US 2005/0013615 A1
(43) Pub. Date: Jan. 20, 2005

(54) Optical add-drop apparatus and method

(76) Inventor: Osamu Matsuda, Tokyo (JP)

Correspondence Address: YOUNG & THOMPSON, 745 SOUTH 23RD STREET, 2ND FLOOR, ARLINGTON, VA, 22202, US

(21) Appl. No.: 10/859,315

(22) Filed: Jun. 3, 2004

(30) Foreign Application Priority Data
Jun. 5, 2003 (JP) 160950/2003

(51) Int. Cl. H04J 14/02

(52) U.S. Cl. 398/83

(57) ABSTRACT

A wavelength variable filter (111) separates an input signal into a passing signal and an intermediate output signal. A wavelength variable filter (112) separates the intermediate output signal into a dropped signal and an extended output signal. An interleaver (120) separates the dropped signal into individual dropped channels. An intrerleaver (220A) multiplexes a plurality of addition channels into an added signal. A wavelength variable filter (212) multiplexes the added signal and an extended input signal to produce an intermediate input signal. A wavelength variable filter (211) multiplexes the passing signal and the intermediate input signal into an output signal. A wavelength setting portion (100) sets a wavelength of each wavelength variable filter in accordance with operation of an operator.

This application claims priority to prior Japanese patent application JP 2003-160950, the disclosure of which is incorporated herein by reference.

### BACKGROUND OF THE INVENTION

This invention relates to an optical add-drop apparatus for use in an optical wavelength multiplex transmission system.

The optical add-drop apparatus is an apparatus for picking up a light signal having a particular wavelength from a wavelength-multiplexed signal (an input signal) and for adding a light signal having the particular wavelength to a through signal to produce an output signal.

Such an optical add-drop apparatus is disclosed, for example, in U.S. Pat. No. 6,452,703 issued to Sung-jun Kim et al. According to Kim, a first conventional optical add-drop apparatus comprises a wavelength group demultiplexer (DMUX), a wavelength group multiplexer (MUX), a channel selector, and a channel multiplexer, in the manner which will later be described in conjunction with FIG. 1. The wavelength group DMUX demultiplexes N input channels into wavelength groups of a predetermined number. One of the wavelength groups is supplied to the channel selector which separates it into individual drop channels. Add channels are supplied to the channel multiplexer which multiplexes them into one wavelength group. The wavelength group MUX multiplexes the wavelength groups passing through the wavelength group DMUX and the wavelength group in the channel multiplexer to produce an output signal.

However, the first conventional optical add-drop multiplexer is disadvantageous in that it is impossible to extend the channel number of the channel selector beyond the predetermined prepared number or more. The channel selector has a maximum channel number. In order to increase the channel number of the channel selector beyond the maximum channel number, it is necessary to exchange the channel selector for a new channel selector having a lot of channels. On exchanging the channel selector for the new channel selector, communication channels for dropped signals are temporarily interrupted. In order to prevent this, it is necessary to prepare a channel selector having a large number of channels. It results in making a large initial investment in preparing such a channel selector.

Various other prior art documents related to this invention are already known. By way of example, a light branching/inserting apparatus is disclosed in U.S. Pat. No. 6,538,782 issued to Kazue Otsuka et al. According to Otsuka, the light branching/inserting apparatus can easily manage the wavelength of signal light and branch, insert or transmit the signal light having optical number of multiplexing and optically multiplexed transmitting signal light of optical wavelength by using a wavelength selecting filter utilizing an acoustic0optical effect.

An optical wavelength multiplex network is disclosed in U.S. Pat. No. 6,351,323 issued to Hiroshi Onaka et al. According to Ohaka, the optical wavelength multiplex network uses an acoustooptic tunable filter (AOTF) and has high reliability and high cost performance.

Disclosed in the above-mentioned U.S. Pat. No. 6,538,782 or 6,351,323, a second conventional optical add-drop apparatus comprises a variable wavelength selecting filter consisting of the AOTF, an output optical amplifier, an output 8×1 coupler, eight wavelength selecting filters, an input 8×1 coupler, and an input optical amplifier, in the manner which will later be described in conjunction with FIG. 2. The variable wavelength selecting filter is supplied with a wavelength multiplexed optical signal as an input signal. Eight waves are added/dropped in the variable wavelength selecting filter. The variable wavelength selecting filter has a drop port for producing a dropped optical signal which is amplified by the output optical amplifier and then is supplied to the output 8×1 coupler. The output 8×1 coupler branches the dropped optical signal into eight branched optical signals which are supplied to the eight wavelength selecting filters each picking up an optical signal having a desired wavelength. Each wavelength selecting filter comprises an AOTF. On the other hand, eight optical signals having respective wavelengths are multiplexed by the input 8×1 coupler, amplified by the input optical amplifier, and are supplied to the variable wavelength selecting filter.

However, the second optical add-drop apparatus is disadvantageous in that it is impossible to extend the channel number into a predetermined prepared number or more. In order to increase the channel number to the output 8×1 coupler, it is necessary to exchange the output 8×1 coupler into an output N×1 coupler having N channels, where N represents an integer which is not less than nine. On exchanging the output 8×1 coupler into the output N×1 coupler, a communication channel for the dropped optical signals is temporarily intercepted. In order to prevent this, it is necessary to prepare an output N×1 coupler having a large number of channels. It results in making a large initial investment in preparing such an output N×1 coupler. In addition, the output optical amplifier is expensive. The second optical add-drop comprises nine expensive filters which are in number more than eight channels of the dropped optical signals.

### SUMMARY OF THE INVENTION

It is an object of this invention to provide an optical add-drop apparatus and method which are capable of extending the channel number which is preliminarily prepared.

It is another object of this invention to provide an optical add-drop apparatus and method which are capable of preventing used channels from interrupting on extending the channel number.

It is still another object of this invention to provide an optical add-drop apparatus and method which are capable of preventing an initial investment from rising in order to make the maximum channel number large.

It is yet another object of this invention to provide an optical add-drop apparatus and method in which an expensive optical amplifier is unnecessary.

It is a further object of this invention to provide an optical add-drop apparatus and method which are capable of preventing the number of expensive filters from needing more than the channel number of the dropped optical signals.

Other objects of this invention will become clear as the description proceeds.

According to an aspect of this invention, an optical add-drop apparatus is for picking up, as a dropped signal, a signal having a particular wavelength from an input signal transmitted in a wavelength-multiplexed fashion and is for adding an added signal to a passing signal to produce an output signal. The optical add-drop apparatus comprises a first demultiplexing unit having an input port for inputting the input signal, a through output port for outputting the passing signal, a drop port for outputting the dropped signal, and an extended output port for outputting an extended output signal. The first demultiplexing unit comprises a demultiplex main wavelength filtering portion for separating the input signal into the passing signal and an intermediate output signal and a demultiplex sub wavelength filtering portion for the intermediate output signal into the dropped signal and the extended output signal. A second demultiplexing unit separates the dropped signal into individual dropped channels. A first multiplexing unit has a though input port for inputting the passing signal, an adding port for inputting the added signal, and an output port for outputting the output signal. The first multiplexing unit multiplexes the passing signal and the added signal to produce the output signal. A second multiplexing unit multiplexes a plurality of addition channels to produce the added signal. Inasmuch as the first demultiplexing unit has, as output ports, not only the through output port and the drop port but also the extended output port, it is possible to easily extend an optical add-drop function and to extend the channel number which is preliminarily prepared beyond it. In addition, it is possible to extend the channel number without interrupting used channels from interrupting on extending the channel number.

In addition, in this invention, the second demultiplexing unit may be an interleaver, interleavers which are connected in a multistage fashion, a combination of a plurality of wavelength filters and a plurality of interleavers, or a colorless AWG. As a result, an expensive optical amplifier is unnecessary.

In this invention, the demultiplex main wavelength filtering portion may comprise a first demultiplex wavelength filter for separating the input signal into the passing signal and the intermediate output signal, the demultiplex sub wavelength filtering portion may comprise a second demultiplex filter for separating the intermediate output signal into the dropped signal and the extended output signal, and the second demultiplexing unit may comprise an interleaver. In this event, if three wavelength filters and three interleavers are connected to the above-mentioned extended output port in a cascade fashion, it is possible to branch into eight channels. That is, it is possible to branch to dropped channels consisting of the eight channels by using the total of five filters. As a result, it is possible to reduce the five filters although expensive nine filters are used in the second conventional optical add-drop apparatus. In this manner, it is possible to reduce number of expensive filters to less than the channel number of the dropped optical signals.

### BRIEF DESCRIPTION OF THE DRAWINGS

FIG. 1 is a block diagram of a first conventional optical add-drop apparatus;

FIG. 2 is a block diagram of a second conventional optical add-drop apparatus;

FIG. 3 is a block diagram of an optical add-drop apparatus according to a first embodiment of this invention;

FIG. 4 is a block diagram showing an applied example of the optical add-drop apparatus illustrated in FIG. 3;

FIG. 5 is a block diagram showing a modified applied example of the optical add-drop apparatus illustrated in FIG. 3;

FIG. 6 is a block diagram of an optical add-drop apparatus according to a second embodiment of this invention;

FIG. 7 is a block diagram showing a first concrete example of the optical add-drop apparatus illustrated in FIG. 6;

FIG. 8 is a view for use in describing operation of a wavelength variable filter used in the optical add-drop apparatus illustrated in FIG. 7;

FIG. 9 is a view for use in describing operation of a wavelength variable filter used in the optical add-drop apparatus illustrated in FIG. 7;

FIG. 10 is a view for use in describing operation of an interleaver used in the optical add-drop apparatus illustrated in FIG. 7;

FIG. 11 is a block diagram for use in describing an example of operation of the optical add-drop apparatus illustrated in FIG. 7;

FIG. 12 is a block diagram for use in describing another example of operation of the optical add-drop apparatus illustrated in FIG. 7;

FIG. 13 is a block diagram showing a second concrete example of the optical add-drop apparatus illustrated in FIG. 6;

FIG. 14 is a block diagram for use in describing operation of a second demultiplexing unit used in the optical add-drop apparatus illustrated in FIG. 13;

FIG. 15 is a view for use in describing operation of a second demultiplexing unit used in the optical add-drop apparatus illustrated in FIG. 13;

FIG. 16 is a block diagram showing another concrete example of a second demultiplexing unit used in the optical add-drop apparatus illustrated in FIG. 3;

FIG. 17 is a block diagram showing still another concrete example of a second demultiplexing unit used in the optical add-drop apparatus illustrated in FIG. 3;

FIG. 18 is a block diagram for use in describing operation of an applied example of the optical add-drop apparatus illustrated in FIG. 7; and

FIG. 19 is a block diagram of an optical add-drop apparatus according to a third embodiment of this invention.

### DESCRIPTION OF THE PREFERRED EMBODIMENTS

Throughout this specification, it is noted that a signal means an optical signal.

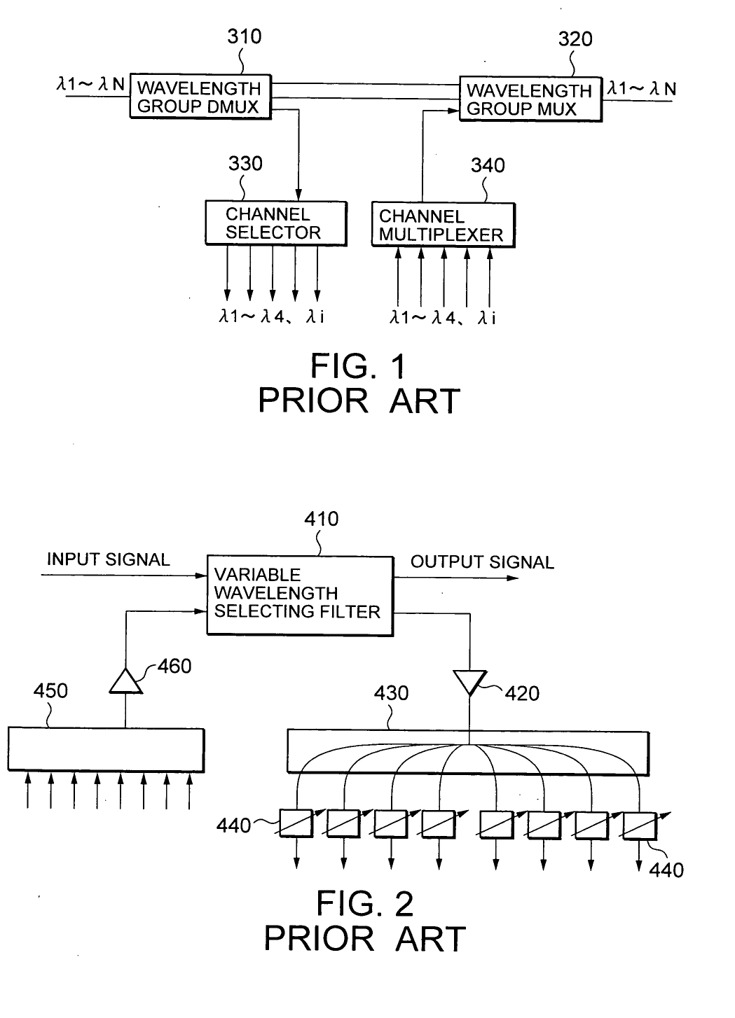

Referring to FIG. 1, a first conventional optical add-drop apparatus will be described at first in order to facilitate an understanding of the present invention.

FIG. 1 is a view showing structure of the first conventional optical add-drop apparatus which is disclosed in the above-mentioned U.S. Pat. No. 6,452,703.

The illustrated optical add-drop apparatus comprises a wavelength group demultiplexer (DMUX) 310, a wavelength group multiplexer (MUX) 320, a channel selector 330, and a channel multiplexer 340.

The wavelength group DMUX 310 demultiplexes N input channels into wavelength groups of a predetermined number. One of the wavelength groups is supplied to the channel selector 330 which separates it into individual drop channels. Add channels are supplied to the channel multiplexer 340 which multiplexes them into one wavelength group. The wavelength group MUX 320 multiplexes the wavelength groups passing through the wavelength group DMUX 310 and the wavelength group in the channel multiplexer 320 to produce an output signal.

However, the first conventional optical add-drop apparatus is disadvantageous in that it is impossible to extend the channel number into a predetermined prepared number or more. This is because the first conventional optical add-drop apparatus comprises the wavelength group DMUX 310 which only has a port for sending a through signal to the wavelength group MUX 320 and a port for sending a dropped signal to the channel selector 330. The channel selector 330 has a maximum channel number. It is difficult to extend the channel number in the channel selector 330 beyond the maximum channel number. In order to increase the channel number of the channel selector 330 beyond the maximum channel number, it is necessary to exchange the channel selector 330 for a new channel selector having a lot of channels. On exchanging the channel selector 330 for the new channel selector, communication channels for the dropped signals are temporarily interrupted. In order to prevent this, it is necessary to prepare a channel selector having a large number of channels. It results in making a large initial investment in preparing such a channel selector, as mentioned in the preamble of the instant specification.

Referring to FIG. 2, a second convention optical add-drop apparatus will be described in order to facilitate an understanding of the present invention. FIG. 2 is a view showing structure of the second conventional optical add-drop apparatus which is disclosed in the above-mentioned U.S. Pat. No. 6,538,782 or 6,351,323.

The illustrated optical add-drop apparatus comprises a variable wavelength selecting filter 410 consisting of an acousto-optic tunable filter (AOTF), an output optical amplifier 420, an output 8×1 coupler 430, eight wavelength selecting filters 440, an input 8×1 coupler 450, and an input optical amplifier 460. The variable wavelength selecting filter 410 is supplied with a wavelength multiplexed optical signal as an input signal. Eight waves are added/dropped in the variable wavelength selecting filter 410. The variable wavelength selecting filter 410 has a drop port for producing a dropped optical signal which is amplified by the output optical amplifier 420 and then is supplied to the output 8×1 coupler 430. The output 8×1 coupler 430 branches the dropped optical signal into eight branched optical signals which are supplied to the eight wavelength selecting filters 440 each picking up an optical signal having a desired wavelength. Each wavelength selecting filter 440 comprises an AOTF. On the other hand, eight optical signals having respective wavelengths are multiplexed by the input 8×1 coupler 450, amplified by the input optical amplifier 460, and are supplied to the variable wavelength selecting filter 410.

However, the second optical add-drop apparatus is disadvantageous in that it is impossible to extend the channel number beyond a predetermined prepared number. This is because the branching number is preliminarily set to a maximum eight channel by the output 8×1 coupler 430. In order to increase the channel number in the output 8×1 coupler 430, it is necessary to exchange the output 8×1 coupler 430 for an output N×1 coupler having N channels, where N represents an integer which is not less than nine. On exchanging the output 8×1 coupler 430 for the output N×1 coupler, communication channels for the dropped optical signals are temporarily interrupted. In order to prevent this, it is necessary to prepare an output N×1 coupler having a large number of channels. It results in making a large initial investment in preparing such an output N×1 coupler, as also mentioned in the preamble of the instant specification.

In addition, inasmuch as branching is carried out by using the output 8×1 coupler 430 in the second conventional optical add-drop apparatus, an expensive output optical amplifier 420 is required as a preceding stage of the output 8×1 coupler 430. This is because the output 8×1 coupler 430 branches one input into eight outputs each having power which is one-eighth as large as power of the input and it is therefore necessary to preliminarily amplify the dropped optical signals by the output optical amplifier 420 before the dropped optical signals are supplied to the output 8×1 coupler 430. Furthermore, inasmuch as the second conventional optical add-drop apparatus comprises the variable wavelength selecting filter 410 and the eight wavelength selecting filters 440, their nine expensive filters are required in the second conventional optical add-drop apparatus. This is because the branching is carried out by the output 8×1 coupler 430, the eight wavelength selecting filters 440 are invariably required at an output side of the output 8×1 coupler 430, and the nine expensive filters obtained by adding the eight wavelength selecting filters 440 and the variable wavelength selecting filter 410 are required in the second conventional optical add-drop apparatus. In the manner which is described above, the second conventional optical add-drop apparatus comprises the nine expensive filters which are in number more than eight channels of the dropped optical signals, as mentioned in the preamble of the instant specification.

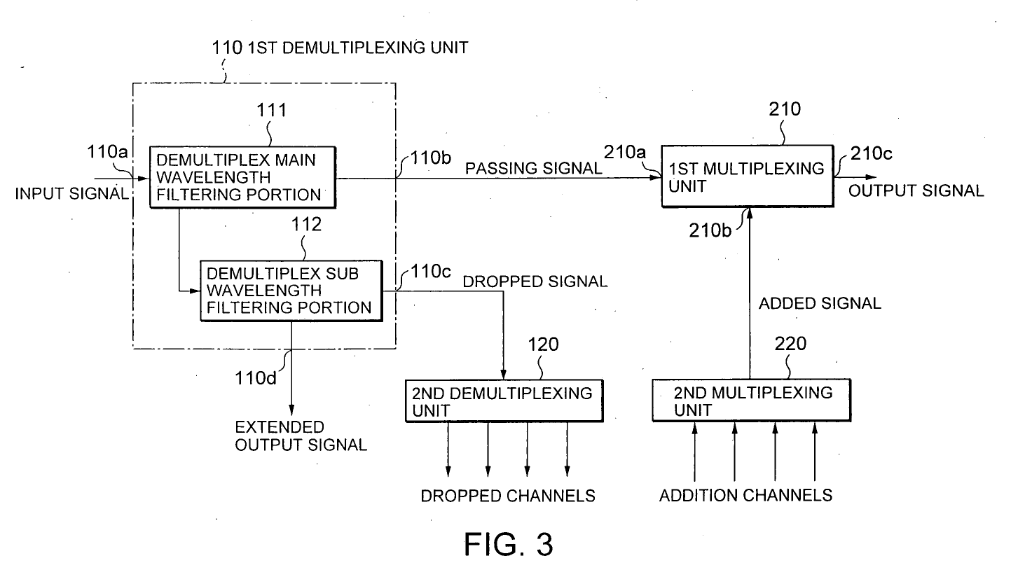

Referring to FIG. 3, the description will proceed to an optical add-drop apparatus according to a first embodiment of this invention. The illustrated optical add-drop apparatus picks up, a dropped signal, a signal having a particular wavelength from an input signal transmitted in a wavelength-multiplexed fashion and adds an add signal to a passing signal to produce an output signal.

The optical add-drop apparatus comprises a first demultiplexing unit 110, a second demultiplexing unit 120, a first multiplexing unit 210, and a second multiplexing unit 220.

The first demutiplexing unit 110 has an input port 110a for inputting the input signal, a through output port 110b for outputting the passing signal, a dropping port 110c for outputting the dropped signal, and an extended output port 110d for outputting the extended output signal.

The first demultiplexing unit 110 comprises a demultiplex main wavelength filtering portion 111 for separating the input signal into the through signal and an intermediate output signal and a demultiplex sub wavelength filtering portion 112 for the intermediate output signal into the dropped signal and the extended output signal. The demultiplex main wavelength filtering portion 111 comprises, for example, a first wavelength variable filter while the demultiplex sub wavelength filtering portion 112 comprises a second wavelength variable filter. A wavelength filter may be used in lieu of the wavelength variable filter.

The second demultiplexing unit 120 separates the dropped signal into individual dropped channels.

The first multiplexing unit 210 has a through input port 210a for inputting the passing signal, an adding port 210b for inputting an added signal, and an output port 210c for outputting the output signal. The first multiplexing unit 210 multiplexes the passing signal and the added signal to produce the output signal.

The second multiplexing unit 220 multiplexes a plurality of addition signals to produce the added signal.

Inasmuch as the first demultiplexing unit 110 has the extended output port 10d, the illustrated optical add-drop apparatus has extensity. Inasmuch as the wavelength variable filters are used as the demultiplex main wavelength filtering portion 111 and the demultiplex sub wavelength filtering portion 112, the illustrated optical add-drop apparatus has flexibility.

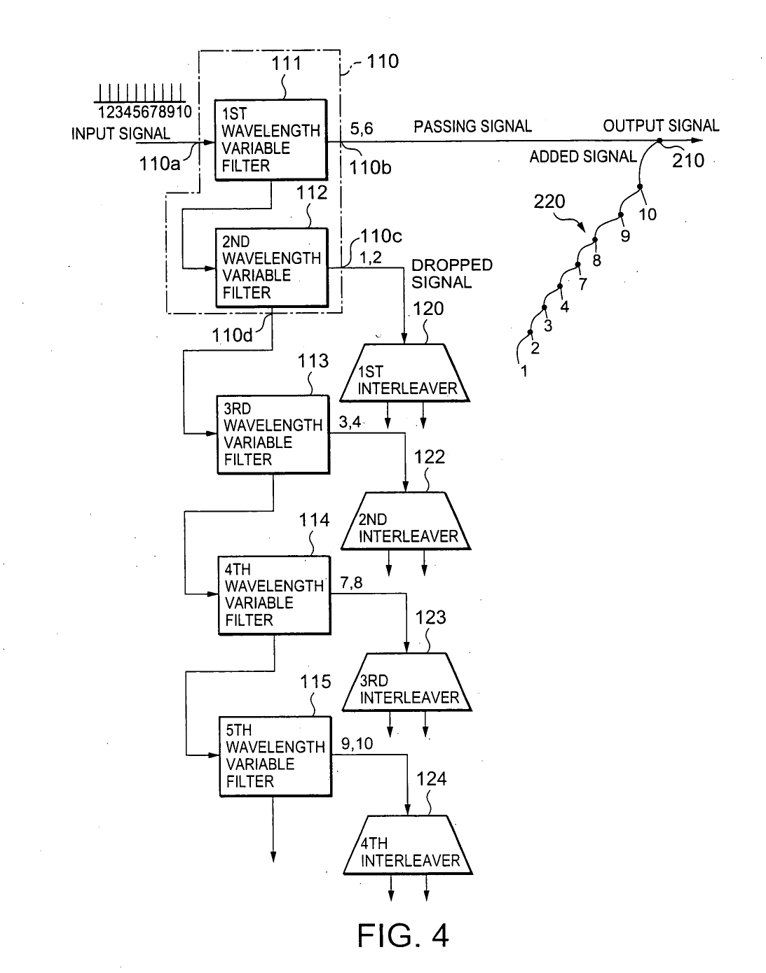

FIG. 4 shows an applied example of the optical add-drop apparatus illustrated in FIG. 3. In the illustrated optical add-drop apparatus, a first interleaver is used as the second demultiplexing unit 120, a first coupler is used as the first multiplexing unit 210, and a second coupler is used as the second multiplexing unit 220.

In addition, third through fifth wavelength variable filters 113, 114, and 115 and second through fourth interleavers 122, 123, and 124 are connected to the extended output port 110d of the first demultiplexing unit 110 in a cascade fashion.

In FIG. 4, it will be assumed that the input signal is a signal obtained by multiplexing first through tenth channel signals. The first wavelength variable filter 111 produces the fifth and the sixth channel signals as the passing signal and produces the remaining channel signals as the intermediate output signal. The second wavelength variable filter 112 separates or demultiplexes the intermediate output signal into the dropped signal consisting of the first and the second channel signals and the extended output signal consisting of the third, the fourth, the seventh, the eighth, the ninth, and the tenth channel signals. The first interleaver 120 separates the dropped signal consisting of the first and the second channel signals into individual dropped channels.

The third wavelength variable filter 113 separates the extended output signal consisting of the third, the fourth, the seventh, the eighth, the ninth, and the tenth channel signals into a dropped signal consisting of the third and the fourth channel signals and an extended output signal consisting of the seventh, the eighth, the ninth, and the tenth channel signals. The second interleaver 122 separates the dropped signal consisting of the third and the fourth channel signals into individual dropped channels.

The fourth wavelength variable filter 114 separates the extended output signal consisting of the seventh, the eighth, the ninth, and the tenth channel signals into a dropped signal consisting of the seventh and the eighth channel signals and an extended output signal consisting of the ninth and the tenth channel signals. The third interleaver 123 separates the dropped signal consisting of the seventh and the eighth channel signals into individual dropped channels.

The fifth wavelength variable filter 115 separates the extended output signal consisting of the ninth and the tenth channel signals into a dropped signal consisting of the ninth and the tenth channel signals and an extended output signal consisting of no channel signal. The fourth interleaver 124 separates the dropped signal consisting of the ninth and the tenth channel signals into individual dropped channels.

The second coupler 220 multiplexes addition channels consisting of the first, the second, the third, the fourth, the seventh, the eighth, the ninth, and the tenth channel signals to produce the added signal. The first coupler 210 multiplexes the passing signal consisting of the fifth and the sixth channel signals and the added signal to produce the output signal.

Inasmuch as the wavelength variable filters 113-115 and the interleavers 122-124 are connected to the extended output port 110d of the first demultiplexing unit 110 in the cascade fashion as illustrated in FIG. 4, it is understood that the optical add-drop apparatus can easily extend and can deal with flexibly. By connecting the extended output port of the wavelength variable filter 115 with a set of another wavelength variable filter and another interleaver for different wavelength, it is possible to increase the number of channels to be dropped.

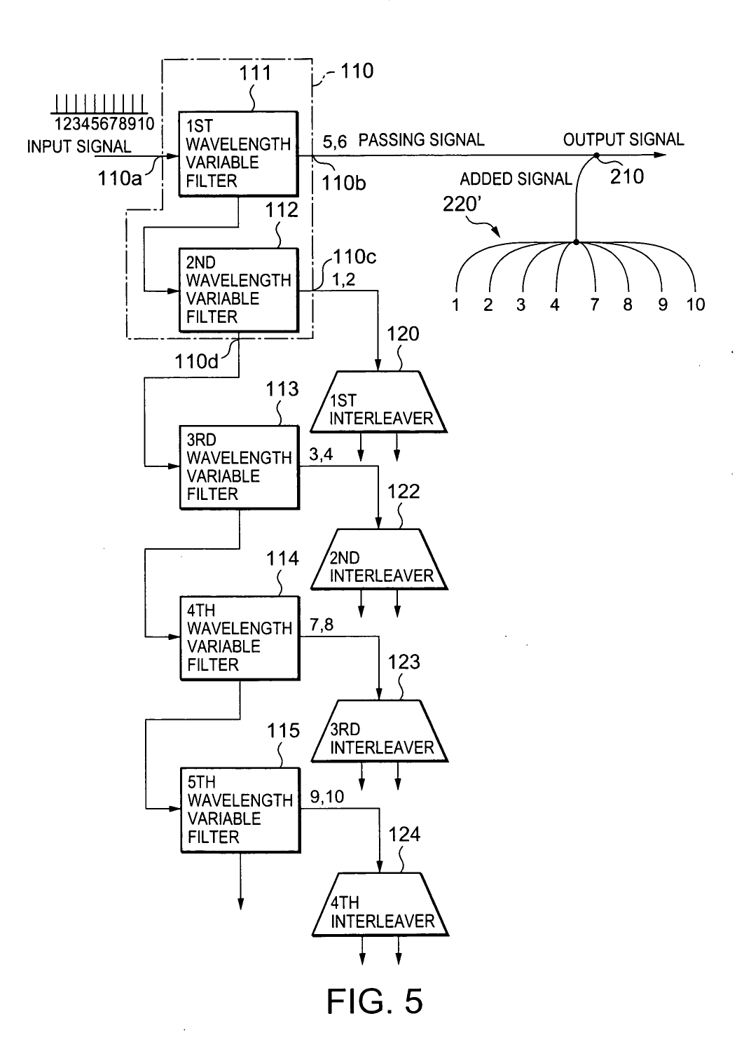

Referring to FIG. 5, the description will proceed to an optical add-drop apparatus according to a modified embodiment of this invention. The illustrated optical add-drop apparatus is similar in structure and operation to the optical add-drop apparatus illustrated in FIG. 4 except that the second multiplexing unit is modified from that illustrated in FIG. 4 as will later become clear. The second multiplexing unit is therefore depicted at 220′.

The second multiplexing unit 220′ comprises a star coupler in place of the second coupler 220.

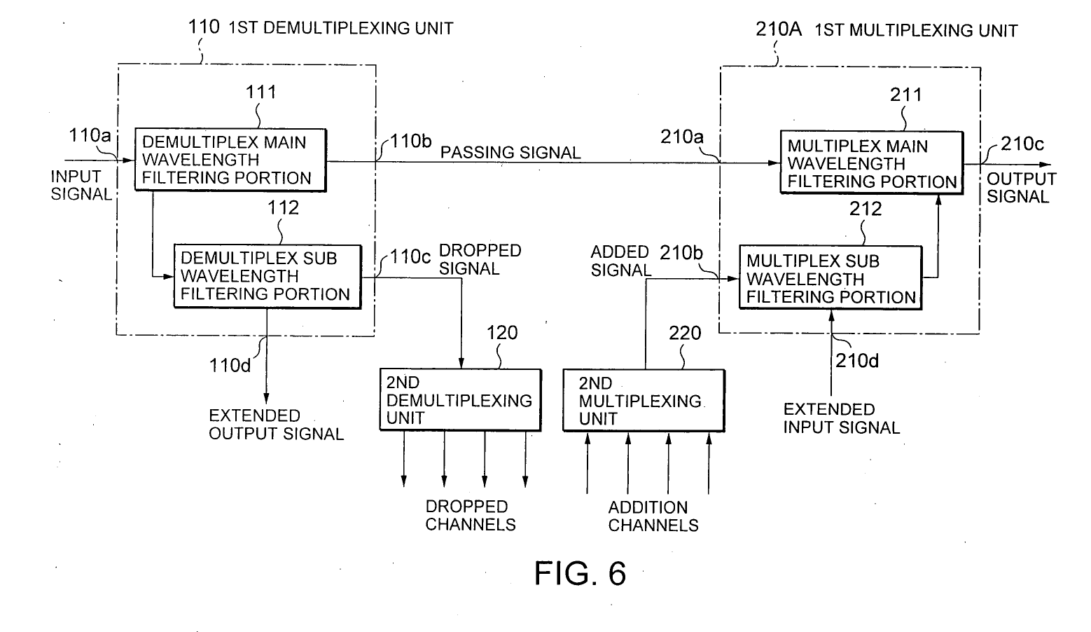

Referring to FIG. 6, the description will proceed to an optical add-drop apparatus according to a second embodiment of this invention. The illustrated optical add-drop apparatus is similar in structure and operation to the optical add-drop apparatus illustrated in FIG. 3 except that the first multiplexing unit further has an extended input port 210d for inputting an extended input signal. The first multiplexing unit is therefore depicted at 210A.

The first multiplexing unit 210A comprises a multiplex main wavelength filtering portion 211 and a multiplex sub wavelength filtering portion 212. The multiplex sub wavelength filtering portion 212 multiplexes the added signal and the extended input signal to produce an intermediate input signal. The multiplex main wavelength filtering portion 211 multiplexes the passing signal and the intermediate input signal to produce the output signal. The multiplex main wavelength filtering portion 211 comprises, for example, a third wavelength variable filter while the multiplex sub wavelength filtering portion 212 comprises a fourth wavelength variable filter. A wavelength filter may be used in lieu of the wavelength variable filter.

Inasmuch as the first demultiplexing unit 110 has the extended output port 110d and the first multiplexing unit 210 has the extended input port 210d, the illustrated optical add-drop apparatus has extensity. Inasmuch as the wavelength variable filters are used as the demultiplex main wavelength filtering portion 111, the demultiplex sub wavelength filtering portion 112, the multiplex main wavelength filtering portion 211, and the multiplex sub wavelength filtering portion 212, the illustrated optical add-drop apparatus has flexibility.

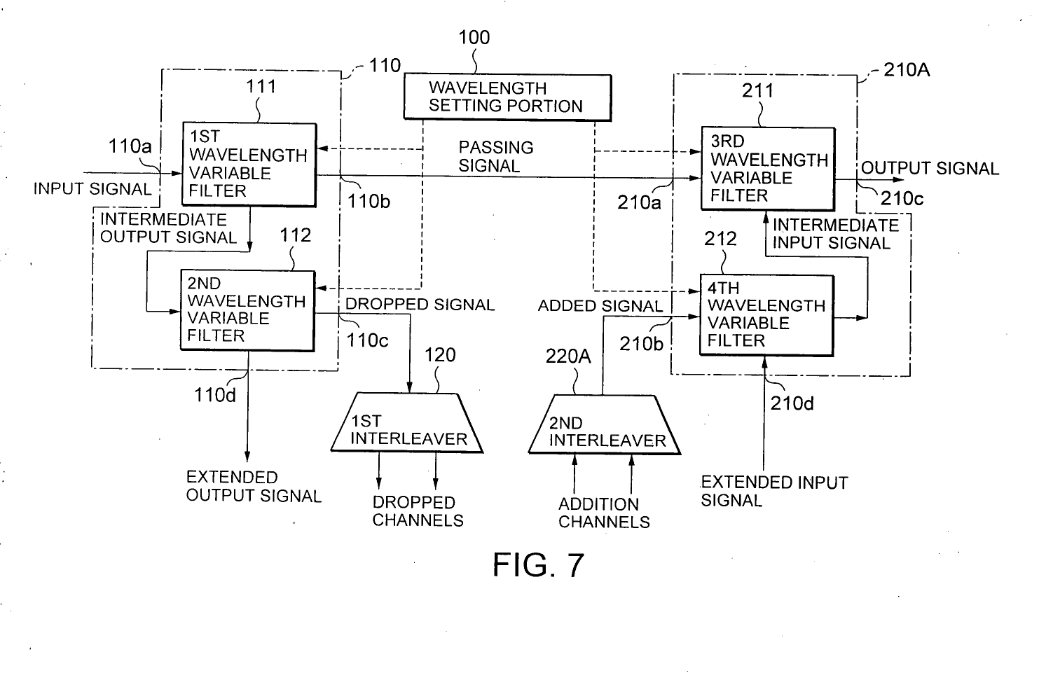

FIG. 7 shows a first concrete example of the optical add-drop apparatus illustrated in FIG. 6. The illustrated optical add-drop apparatus comprises the first interleaver as the second demultiplexing unit 120 and a second interleaver as the second multiplexing unit 220A. A wavelength setting portion 100 is for setting wavelengths in the first through the fourth wavelength variable filters 111, 112, 211, and 212.

In FIG. 7, the first wavelength variable filter 111 demultiplexes or separates the input signal into the passing signal and the intermediate output signal in accordance with setting of the wavelength setting portion 100. The second wavelength variable filter 112 demultiplexes or separates the intermediate output signal into the dropped signal and the extended output signal in accordance with setting of the wavelength setting portion 100. The first interleaver 120 separates the dropped signal into the individual dropped channels.

The second interleaver 220A multiplexes the plurality of addition channels into the added signal. The fourth wavelength variable filter 212 multiplexes the added signal and the extended input signal in accordance with setting of the wavelength setting portion 100 to produce an intermediate input signal. The third wavelength variable filter 211 multiplexes the passing signal and the intermediate input signal in accordance with setting of the wavelength setting portion 100 to produce the output signal.

The wavelength setting portion 100 sets the wavelengths for the first through the fourth wavelength variable filters 111, 112, 211, and 212 in accordance with operation of a user.

The extended output signal produced by the second wavelength variable filter 112 has channel signals except for the above-mentioned passing signal and the dropped signal. Therefore, by connecting the extended output port 110d of the first demultiplexing unit 110 with a set of a wavelength variable filter and an interleaver, it is possible to extend a function of the optical add-drop apparatus. In a case of extending an adding side, it is possible to use the extended input signal supplied to the fourth wavelength variable filter 212.

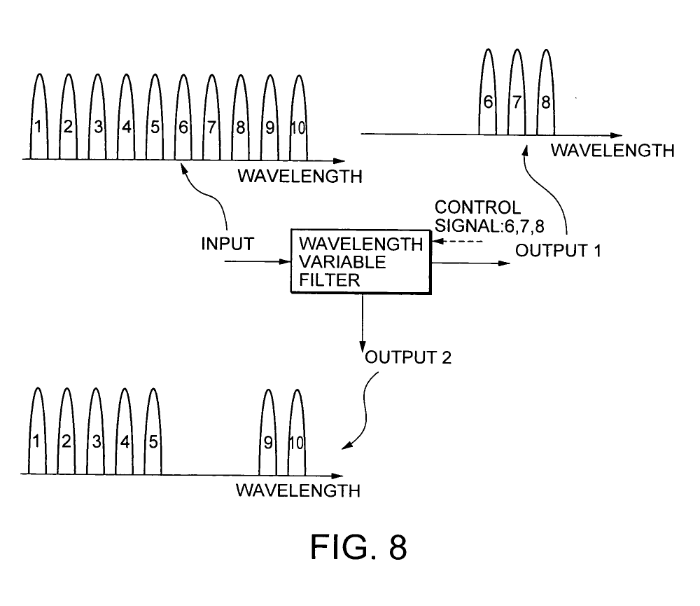

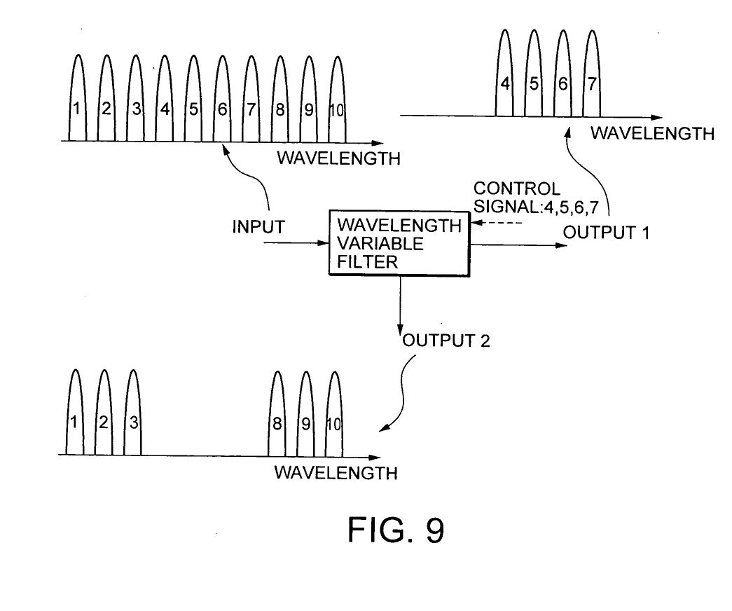

Referring to FIGS. 8 and 9, description will be made as regards operation of the wavelength variable filter shown in FIG. 7.

In FIG. 8, the input signal INPUT is a signal into which ten channel signals having different wavelengths (first through tenth channels) are wavelength-multiplexed. The wavelength variable filter has a first output terminal OUTPUT1 for outputting a first demultiplexed signal and a second output terminal OUTPUT2 for outputting a second demultiplexed signal. In the example being illustrated, the wavelength variable filter is supplied with a control signal indicative of the sixth, the seventh, and the eighth channels. In accordance with an instruction of the control signal, the wavelength variable filter produces the first demultiplexed signal having the sixth, the seventh, and the eighth channels from the first output terminal OUTPUT1 and produces the second demultiplexed signal having the remaining channels from the second output terminal OUTPUT2. In general, a single wavelength variable filter can select a plurality of successive wavelengths (channels) but cannot select any wavelengths (channels) which are not successive. As a result, the wavelength variable filter operates so that a plurality of successive channels are produced at one input terminal while remaining channels are produced at another output terminal.

Turning to FIG. 9, it will be assumed that the wavelength variable filter is supplied with the control signal indicative of the fourth, the fifth, the sixth, and the seventh channels. Under the circumstances, the wavelength variable filter operates so that the first demultiplexed signal having the fourth, the fifth, the sixth, and the seventh channels are produced at the first output terminal OUTPUT1 while the second demultiplexed signal having the remaining channels are produced at the second output terminal OUTPUT2.

Although FIGS. 8 and 9 show examples where the wavelength variable filter carries out operation of one-input and two-outputs, the wavelength variable filter may carry out operation of two-inputs and one-output so that the input and the output in FIGS. 8 and 9 are inverted. That is, the wavelength variable filter is operable as not only a wavelength demultiplexer (an optical demultiplexer) but also a wavelength multiplexer (an optical multiplexer).

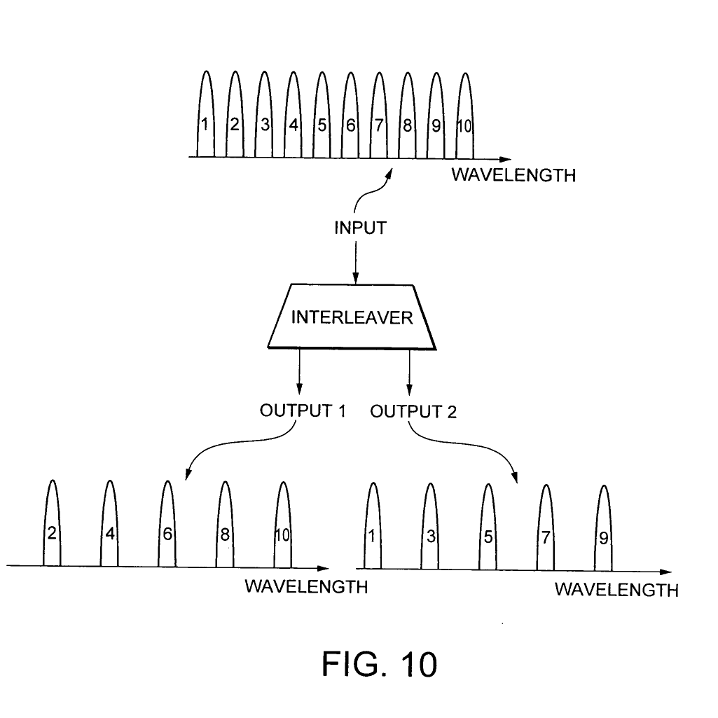

Referring to FIG. 10, description will be made as regards operation of the interleaver shown in FIG. 7. In FIG. 10, the input signal INPUT is a signal into which ten channel signals having different wavelengths (first through tenth channels) are wavelength-multiplexed. The interleaver has a first output terminal OUTPUT1 and a second output terminal OUTPUT2. The interleaver distinguishes even channels and odd channels in the input signal to produce a first output signal having the even channels from the first output terminal OUTPUT1 and a second output signal having the odd channels from the second output terminal OUTPUT2.

Although FIG. 10 shows an example where the interleaver carries out operation of one-input and two-outputs, the interleaver may carries out operation in bidirectional like in the wavelength variable filter. That is, the interleaver may carry out operation of two-inputs and one-output so that the input and the output in FIG. 10 are inverted. Namely, the interleaver is operable as not only a wavelength demultiplexer (an optical demultiplexer) but also a wavelength multiplexer (an optical multiplexer).

Although the description has been made structure of the optical add-drop apparatus according to the second embodiment of this invention in detailed, the wavelength setting portion 100 only carries out operation for delivering the wavelength designated by a management system to each wavelength variable filter and is not directly related to this invention. Therefore, detailed structure of the wavelength setting portion 100 is omitted. In addition, although variable methods are known with regard to internal structure of the wavelength variable filter and the interleaver, the wavelength variable filter and the interleaver are not directly related to this invention and detailed structure thereof is therefore omitted. As the wavelength variable filter, an AO filter, a dielectric multilayer film filter, a variable wavelength FBG, or the like may be used.

Although the above-mentioned optical add-drop apparatus according to the second embodiment of this invention comprises the interleaver having two output ports, an interleaver having three or more output ports may be used. When an interleaver having four output ports is used, the second wavelength variable filter 112 may select maximum four successive waves as the dropped signal.

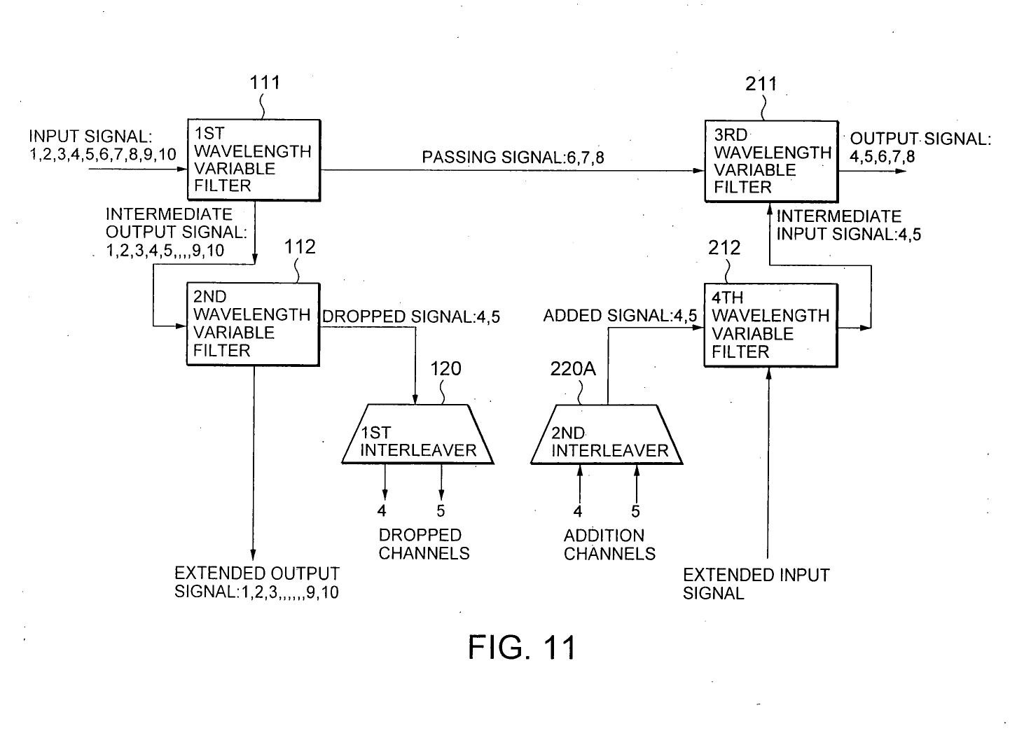

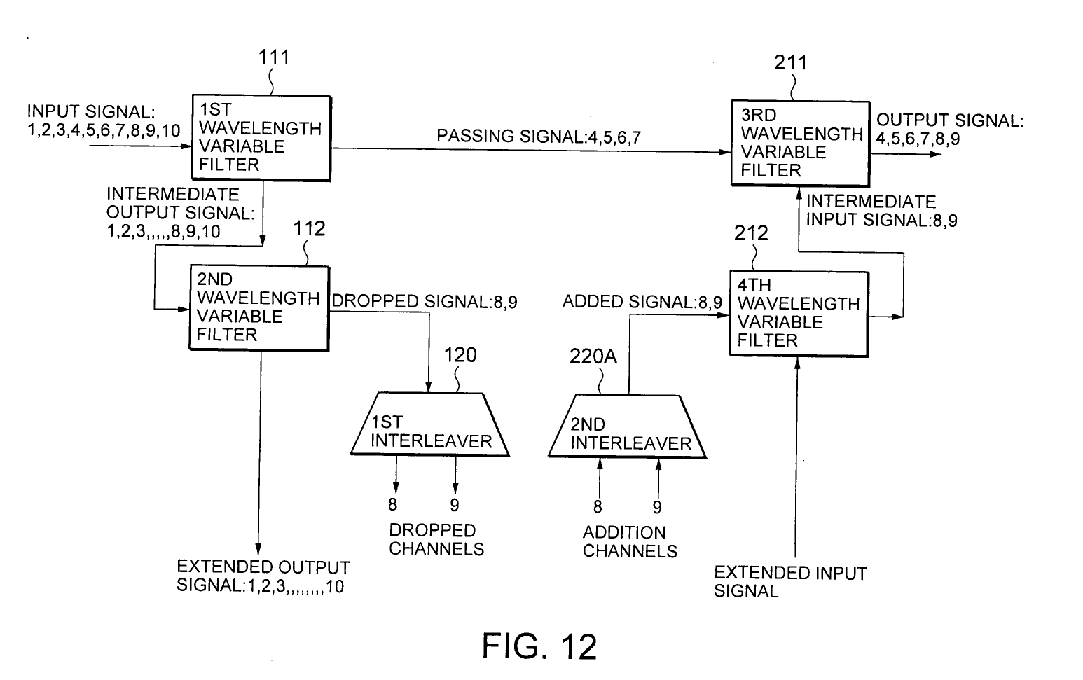

Referring now to FIGS. 11 and 12, description will be made as regards operation of the optical add-drop apparatus illustrated in FIG. 4. In FIGS. 11 and 12, the wavelength setting portion 100, which is not directly concerned to an add-drop operation, is omitted.

In FIG. 11, three channels, namely, the sixth, the seventh, and the eighth channels are set in the first and the third wavelength variable filters 111 and 211 as the passing signal and two channels, namely, the second and the fourth channels are set in the second and the fourth wavelength variable filters 112 and 212 as the dropped signal and the added signal, respectively. It will be assumed that the input signal has ten channels from the first to the tenth channels.

The first wavelength variable filter 111 produces, as the passing signal, a signal having the three channels consisting of the sixth, the seventh, and the eighth channels.

The first wavelength variable filter 111 produces, as the intermediate output signal, a signal having the remain seven channels consisting of the first, the second, the third, the fourth, the fifth, the ninth, and the tenth channels. The signal having those seven channels is supplied to the second wavelength variable filter 112 which produces, as the dropped signal, a signal having the fourth and the fifth channels.

The second wavelength variable filter 112 produces, as the extended output signal, a signal having the first, the second, the ninth, and the tenth channels which do not appear in both of the passing signal and the dropped signal.

The second interleaver 220A multiplexes addition channels consisting of the fourth and the fifth channels to produce the added signal. The fourth wavelength variable filter 212 multiplexes the added signal having the fourth and the fifth channels from the second interleaver 220A and the extended input signal to produce the intermediate input signal. Inasmuch as the extended input signal is absent in this example, the fourth wavelength variable filter 212 produces, as the intermediate input signal, a signal having two channels consisting the fourth and the fifth channels.

The third wavelength variable filter 211 multiplexes the passing signal having three channels consisting of the sixth, the seventh, and the eighth channels from the first wavelength variable filter 111 and the intermediate input signal having two cannels consisting of the fourth and the fifth channels from the fourth wavelength variable filter 212 to produce, as the output signal, a signal having the fourth, the fifth, the sixth, the seventh, and the eighth channels.

As shown in FIG. 12, the first and the third wavelength variable filters 111 and 211 are set with, as the passing signal, four channels consisting of the fourth, the fifth, the sixth, and the seventh channels while the second and the fourth wavelength variable filters 112 and 212 are set with, as the dropped signal and the added signal, two channels consisting of the eighth and the ninth channels. It will be assumed that the input signal has ten channels consisting of the first through the tenth channels like in FIG. 11.

The first wavelength variable filter 111 produces, as the passing signal, as a signal having four channels consisting of the fourth, the fifth, the sixth, and the seventh channels.

The first wavelength variable filter 111 produces, as the intermediate output signal, a signal having the remaining six channels consisting of the first, the second, the third, the eighth, the ninth, and the tenth channels. The signal having the remaining six channels is supplied to the second wavelength variable filter 112 which produces, as the dropped signal, a signal having the eighth and the ninth channels which are set therein.

The dropped signal is separated by the first interleaver 120 into individual channels consisting of the eighth and the ninth channels which are dropped.

The second wavelength variable filter 112 produces, as the extended output signal, a signal having the first, the second, the third, and the tenth channels which do not appear in both of the passing signal and the dropped signal.

The second interleaver 220A multiplexes the addition channels consisting of the eighth and the ninth channels to produce the added signal. The fourth wavelength variable filter 212 multiplexes the added signal having the eighth and the ninth channels from the second interleaver 220A and the extended input signal to produce the intermediate input signal. Inasmuch as the extended input signal is absent in this example, the fourth wavelength variable filter 212 produces, as the extended input signal, a signal having two channels of the eighth and the ninth channels.

In the manner which is described above, the optical add-drop apparatus according to the second embodiment of this invention takes effect as follows. Inasmuch as the passing signal is selected by the first and the third wavelength variable filters 111 and 211 and the dropped signal and the added signal are selected by the second and the fourth wavelength variable filers, respectively, it is possible to select any wavelengths to be dropped and added from the input signal which is transmitted with wavelength-multiplexed. In addition, inasmuch as the wavelength variable filter produces the extended output signal or inputs the extended input signal, it is possible to easily extend a function of the optical add-drop apparatus.

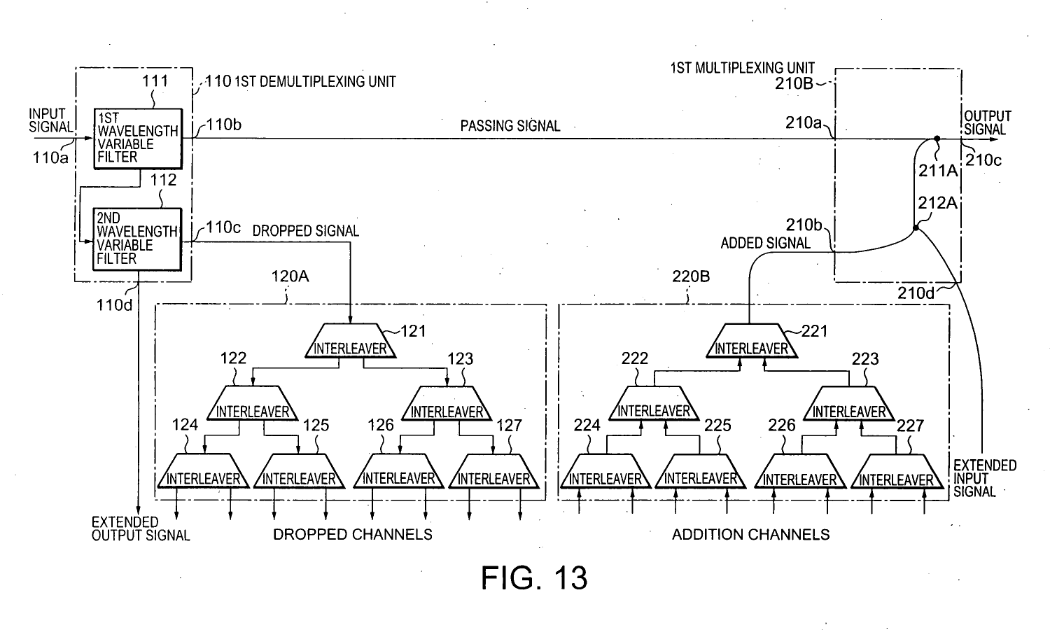

FIG. 13 shows a second concrete example of the optical add-drop apparatus illustrated in FIG. 6. The illustrated optical add-drop apparatus uses, as a second demultiplexing unit 120A, a circuit comprising a plurality of interleavers which are connected in a multi-stage fashion and uses, as a second multiplexing unit 220B, a circuit comprising a plurality of interleavers which are connected in a multi-stage fashion. A first multiplexing unit 210B uses, as the multiplex main wavelength filtering portion, a first coupler 211A and uses, as the multiplex sub wavelength filtering portion, a second coupler 212A.

The second demultiplexing unit 120A comprises first through seventh demultiplex interleavers 121 to 127. Likewise, the second multiplexing unit 220B comprises first through seventh multiplex interleavers 221 to 227.

In the example being illustrated, the second demultiplexing unit 120A is supplied with, as the dropped signal, a signal having successive eight channels. The second demultiplexing unit 120A separates or demultiplexes the dropped signal having the successive eight channels into individual dropped channels.

Similarly, the second multiplexing unit 220B is supplied with, as the addition channels, a signal having successive eight channels. The second multiplexing unit 220B multiplexes the addition channels consisting of the successive eight channels to produce the added signal.

On the other hand, in the first multiplexing unit 210B, the second coupler 212A multiplexes the added signal and the extended input signal to produce the intermediate input signal and the first coupler 211A multiplexes the passing signal and the intermediate input signal to produce the output signal.

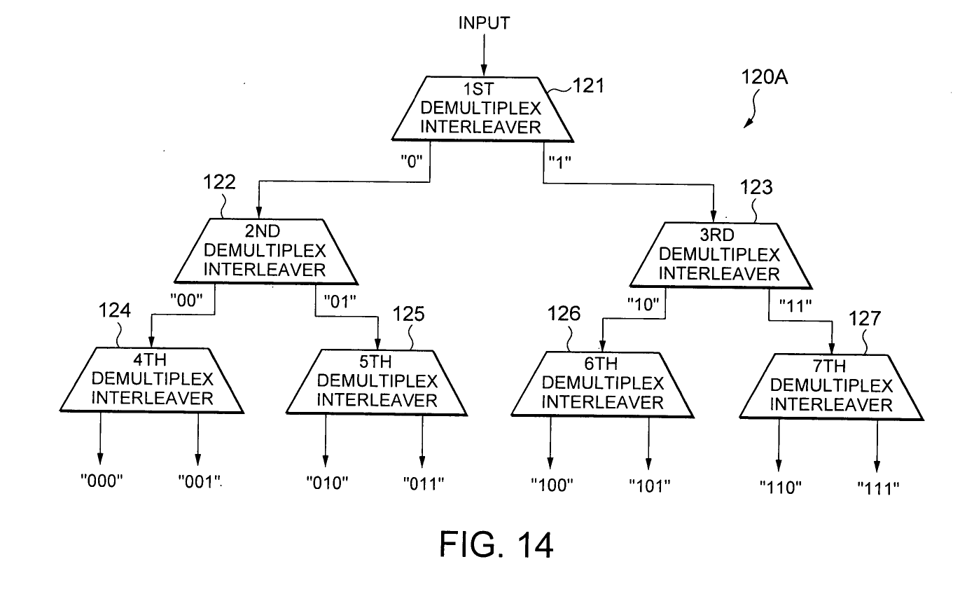

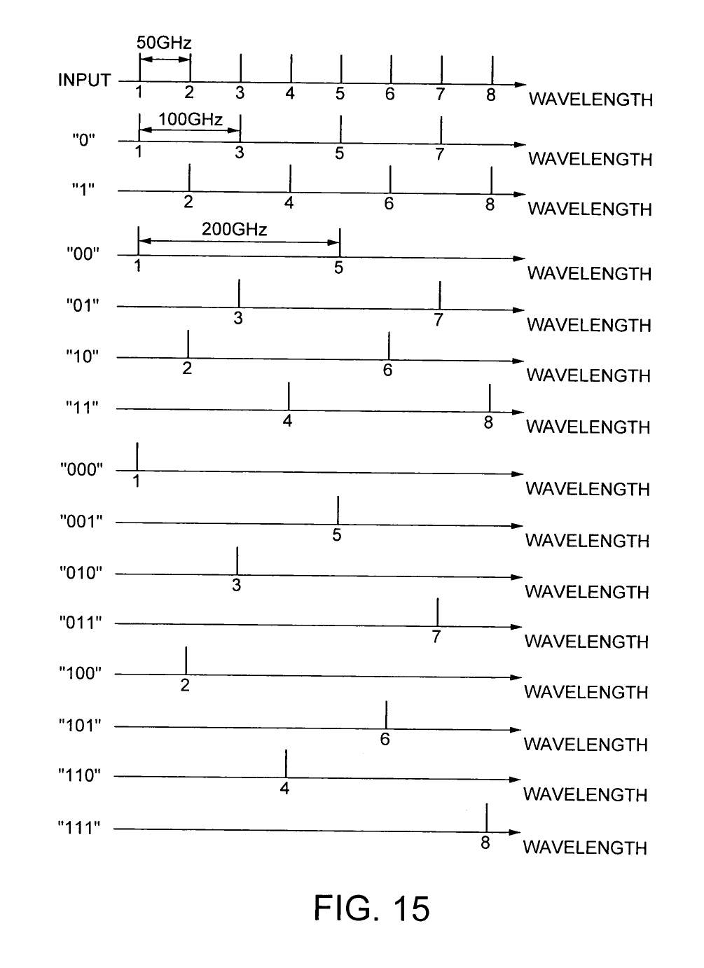

Referring now to FIGS. 14 and 15, description will be made as regards operation of the second demultiplexing unit 120A illustrated in FIG. 13.

In the manner which is shown along a first line of FIG. 15, it will be assumed that the second demultiplexing unit 120A is supplied with, as the dropped signal, a signal having first through eighth channels which are successive in a frequency interval of 50 GHz.

In addition, an interleaver having an interval of 100 GHz is used as the first demultiplex interleaver 121, an interleaver having an interval of 200 GHz is used as each of the second and the third demultiplex interleavers 122 and 123, and an interleaver having an interval of 400 GHz is used as each of the fourth through the seventh interleavers 124 to 127.

As shown in FIG. 14, the first demultiplex interleaver 121 has a “0” output terminal and a “1” output terminal. The “0” output terminal of the first demultiplex interleaver 121 is connected to an input terminal of the second demultiplex interleaver 122. The “1” output terminal of the first demultiplex interleaver 121 is connected to an input terminal of the third demultiplex interleaver 123. The second demultiplex interleaver 122 has a “00” output terminal and a “Ol” output terminal. The third demultiplex interleaver 123 has a “10” output terminal and a “11” output terminal. The “00” output terminal of the second demultiplex interleaver 122 is connected to an input terminal of the fourth demultiplex interleaver 124. The “01” output terminal of the second demultiplex interleaver 122 is connected to an input terminal of the fifth demultiplex interleaver 125. The “10” output terminal of the third demultiplex interleaver 123 is connected to an input terminal of the sixth demultipex interleaver 126. The “11” output terminal of the third demultiplex interleaver 123 is connected to an input terminal of the seventh demultiplex interleaver 127. The fourth demultiplex interleaver 124 has a “000” output terminal and a “001” output terminal. The fifth demultilpex interleaver 125 has a “010” output terminal and a “011” output terminal. The sixth demultiplex interleaver 126 has a “100” output terminal and a “101” output terminal. The seventh demultiplex interleaver 127 has a “110” output terminal and a “111” output terminal.

Under the circumstances, the first demultiplex interleaver 121 produces a signal having the first, the third, the fifth, and the seventh channels in a frequency interval of 100 GHz from the “0” output terminal (see a second line of FIG. 15) and produces a signal having the second, the fourth, the sixth, and the eighth channels in a frequency interval of 100 GHz from the “1” output terminal (see a third line of FIG. 15).

The signal having the first, the third, the fifth, and the seventh channels is supplied to the second demultiplex interleaver 122 while the signal having the second, the fourth, the sixth, and the eighth channels is supplied to the third demultiplex interleaver 123. The second demultiplex interleaver 122 produces a signal having the first and the fifth channels in a frequency interval of 200 GHz from the “00” output terminal (see a fourth line of FIG. 15) and produces a signal having the third and the seventh channels in a frequency interval of 200 GHz from the “01” output terminal (see a fifth line of FIG. 15). The third demultiplex interleaver 123 produces a signal having the second and the sixth channels in a frequency interval of 200 GHz from the “10” output terminal (see a sixth line of FIG. 15) and produces a signal having the fourth and the eighth channels in a frequency internal of 200 GHz from the “11” output terminal (see a seventh line of FIG. 15).

The signal having the first and the fifth channels is supplied to the fourth demultipex interleaver 124, the signal having the third and the seventh channels is supplied to the fifth demultiplex interleaver 125, the signal having the second the sixth channels is supplied to the sixth demultiplex interleaver 126, and the signal having the fourth and the eighth channels is supplied to the seventh demultiplex interleaver 127.

The fourth demultiplex interleaver 124 produces a signal having the first channel from the “000” output terminal (see an eighth line of FIG. 15) and produces a signal having the fifth channel from the “001” output terminal (see a ninth line of FIG. 15). The fifth demultiplex interleaver 125 produces a signal having the third channel from the “010” output terminal (see a tenth line of FIG. 15) and produces a signal having the seventh channel from the “011” output terminal (see an eleventh line of FIG. 15). The sixth demultiplex interleaver 126 produces a signal having the second channel from the “100” output terminal (see a twelfth line of FIG. 15) and produces a signal having the sixth channel from the “101” output terminal (see a thirteenth line of FIG. 15). The seventh demultiplex interleaver 127 produces a signal having the fourth channel from the “110” output terminal (see a fourteenth line of FIG. 15) and produce a signal having the eighth channel from the “111” output terminal (see a fifteenth line of FIG. 15).

The second multiplexing unit 220B carries out inverse operation from that of the above-mentioned demultiplexing unit 120A.

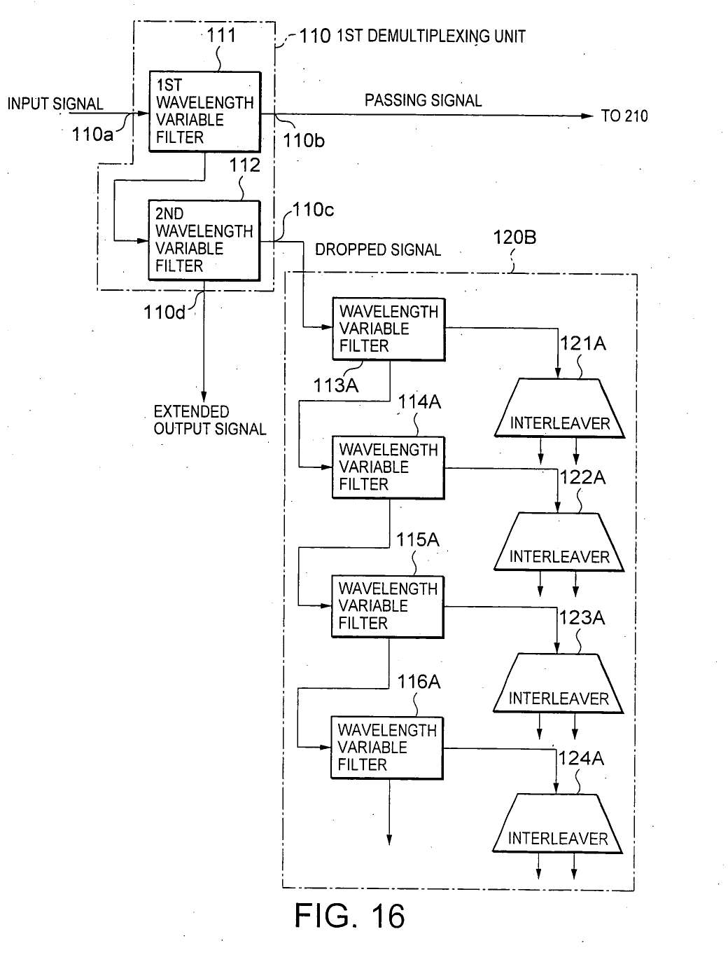

FIG. 16 shows another concrete example of the second demultiplexing unit. The illustrated second demultiplexing unit 120B comprises a combination of four wavelength variable filters 113A, 114A, 115A, and 116A and four interleavers 121A, 122A, 123A, and 124A.

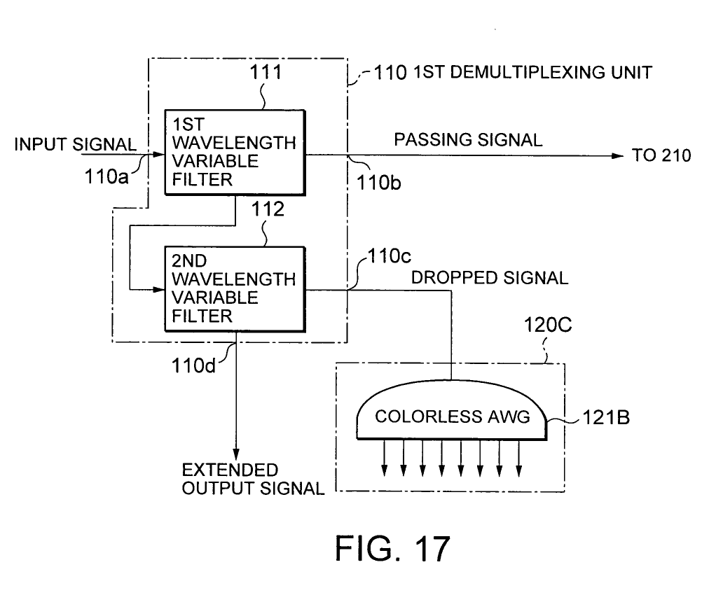

FIG. 17 shows still another concrete example of the second demultiplexing unit. The illustrated second demultiplexing unit 120B comprises a colorless AWG 121B.

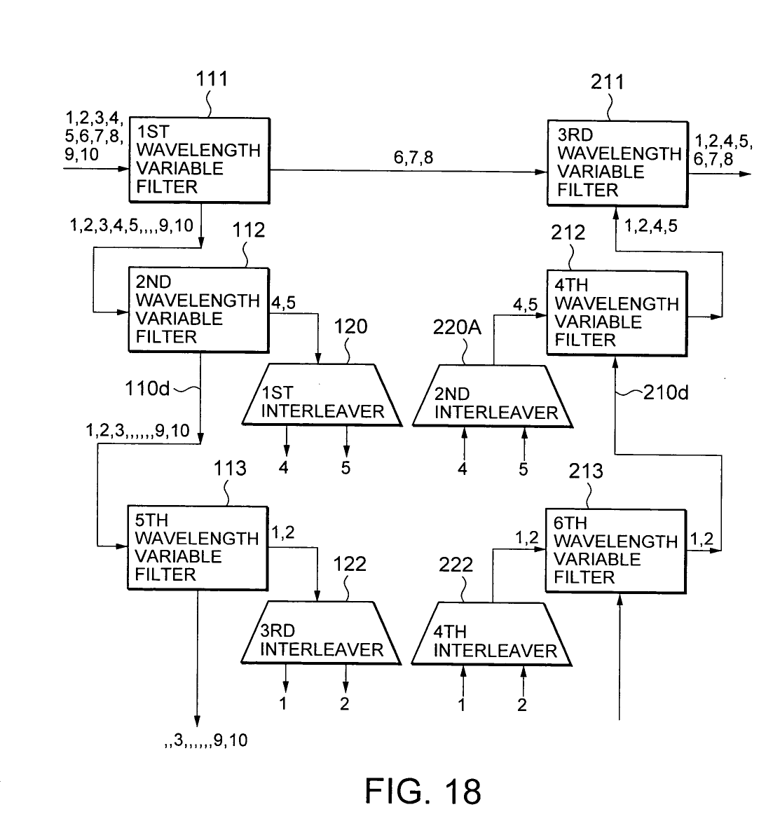

FIG. 18 shows an applied example of the optical add-drop apparatus illustrated in FIG. 7. In the illustrated optical add-drop apparatus, a fifth wavelength variable filter 113 and a third interleaver 122 are connected to the extended output port 110d of the second wavelength variable filter 122 in a cascade fashion, a sixth wavelength variable filter 213 and a fourth interleaver 222 are connected to the extended input port 210d of the fourth wavelength variable filter 212 in a cascade fashion.

In FIG. 18, three channels consisting of the sixth, the seventh, and the eighth channels are set in the first and the third wavelength variable filters 111 and 211 as the passing signal, two channels consisting of the fourth and the fifth channels are set in the second and the fourth wavelength variable filters 122 and 212 as the dropped signal and the added signal. In addition, two channels consisting of the first and the second channels are set in the fifth and the sixth wavelength variable filters 113 and 213 as a dropped signal and an added signal. It will be assumed that the input signal has ten channels consisting of the first through the tenth channels.

The first wavelength variable filter 111 produces, as the passing signal, a signal having three channels consisting of the sixth, the seventh, and the eighth channels.

The first wavelength variable filter 111 produces, as the intermediate output signal, a signal having the remaining seven channels consisting of the first, the second, the third, the fourth, the fifth, the ninth, and the tenth channels. The signal having the seven channels is supplied to the second wavelength variable filter 112. The second wavelength variable filter 112 produces, as the dropped signal, a signal having the fourth and the fifth channels which are set therein. The dropped signal is separated by the first interleaver 120 into individual channels consisting of the fourth and the fifth channels which are dropped.

The second wavelength variable filter 112 produces, as the extended output signal, a signal having five channels consisting of the first, the second, the ninth, and the tenth channels which are not present in both of the passing signal and the dropped signal. The signal having the five channels is supplied to the fifth wavelength variable filter 113. The fifth wavelength variable filter 113 produces, as an additional dropped signal, a signal having the first and the second channels which are set therein. The additional dropped signal is separated by the third interleaver 122 into individual channels consisting of the first and the second channels which are dropped.

The fourth interleaver 222 multiplexes addition channels consisting of the first and the second channels to produce an additional added signal. The sixth wavelength variable filter 213 multiplexes the additional added signal having the first and the second channel from the fourth interleaver 222 and an additional extended input signal to produce the extended input signal. Inasmuch as the additional extended input signal is absent in this example, the sixth wavelength variable filter 213 produces, as the extended input signal, a signal having two channels consisting of the first and the second channels.

The second interleaver 220A multiplexes addition channels consisting of the fourth and the fifth channels to produce the added signal. The fourth wavelength variable filter 212 multiplexes the added signal having the fourth and the fifth channels from the second interleaver 220A and the extended input signal to produce the intermediate input signal. Inasmuch as the extended input signal has two channels consisting of the first and the second channels in this example, the fourth wavelength variable filter 212 produces, as the intermediate input signal, a signal having four channels consisting of the first, the second, the fourth, and the fifth channels.

The third wavelength variable filter 211 multiplexes the passing signal having three channels consisting of the sixth, the seventh, and the eighth channels from the first wavelength variable filter 111 and the intermediate input signal having four channels consisting of the first, the second, the fourth, and the fifth channels from the fourth wavelength variable filter 212 to produce, as the output signal, a signal having the first, the second, the fourth, the fifth, the sixth, the seventh, and the eighth channels.

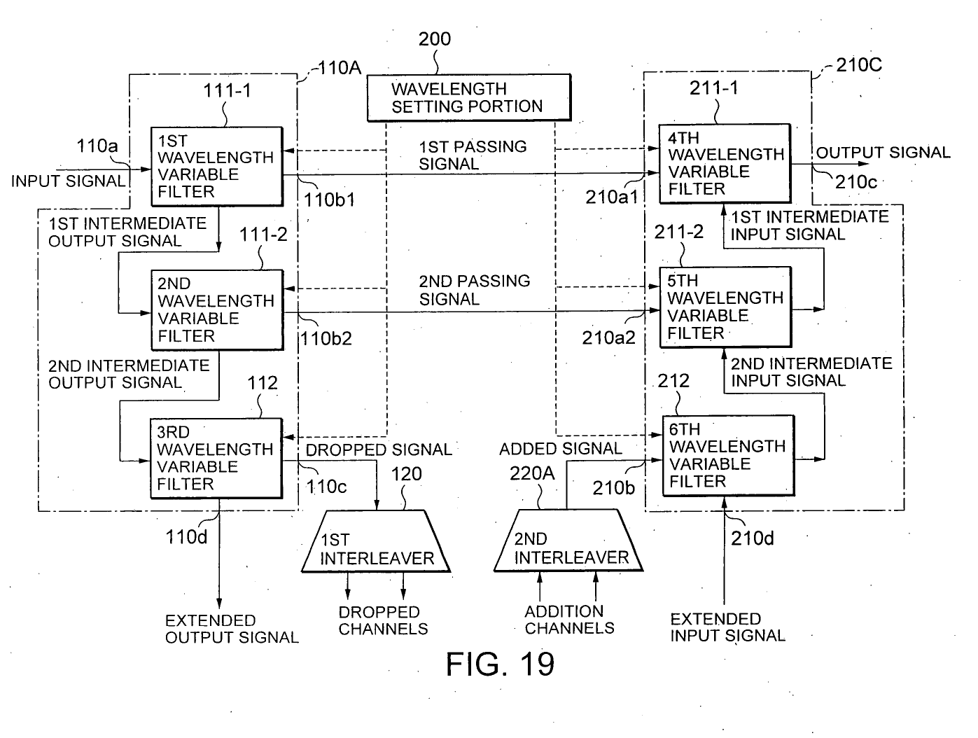

Referring to FIG. 19, the description will proceed to an optical add-drop apparatus according to a third embodiment of this invention. The illustrated optical add-drop apparatus is similar in structure and operation to the optical add-drop apparatus illustrated in FIG. 7 except that the first demultiplexing unit and the first multiplexing unit are modified from those illustrated in FIG. 7 as will later become clear and the wavelength setting portion is modified from that illustrated in FIG. 7. The first demultiplexing unit, the first multiplexing unit, and the wavelength setting portion are therefore depicted at 110A, 210A, and 200. The similar reference symbols are attached to those having similar functions in illustrated in FIG. 7.

The illustrated optical add-drop apparatus shows an example devised so as to make a plurality of wavelength bands the passing signal.

The first demultiplexing unit 110A has first and second through output ports 110b and 110b2 for outputting first and second passing signals. The demultiplex main wavelength filtering portion consists of first and second wavelength variable filters 111-1 and 111-2. The first wavelength variable filter 111-1 separates or demultiplexes the input signal into the first passing signal and a first intermediate output signal. The second wavelength variable filter 111-2 separates or demultiplexes the first intermediate output signal into the second passing signal and a second intermediate output signal. The demultiplex sub wavelength filtering portion consists of a third wavelength variable filter 112 for separating or demultiplexing the second intermediate output signal into the dropped signal and the extended output signal.

The first multiplexing unit 210C has first and second through input ports 210a1 and 210a2 for inputting the first and the second passing signals. The multiplex main wavelength filtering portion consists of fourth and fifth wavelength variable filters 211-1 and 211-2. The multiplex sub wavelength filtering portion consists of a sixth wavelength variable filter 212. The sixth wavelength variable filter 212 multiplexes the added signal and the expanded input signal to produce a second intermediate input signal. The fifth wavelength variable filter 211-2 multiplexes the second passing signal and the second intermediate signal to produce a first intermediate input signal. The fourth wavelength variable filter 211-1 multiplexes the first passing signal and the first intermediate input signal to produce the output signal.

The first wavelength variable filter 111-1 separates the input signal into the first passing signal and the first intermediate output signal in accordance with setting of the wavelength setting portion 200. The second wavelength variable filter 111-2 separates the first intermediate output signal from the first wavelength variable filter 111-1 into the second passing signal and the second intermediate output signal in accordance with setting of the wavelength setting portion 200. The third wavelength variable filter 112 separates the second intermediate output signal into the dropped signal and the extended output signal in accordance with setting of the wavelength setting portion 200. The first interleaver 120 separates the dropped signal from the third wavelength variable filter 112 into individual dropped channels.

The second interleaver 220A multiplexes the addition channels to produce the added signal. The sixth wavelength variable filter 212 multiplexes the added signal from the second interleaver 220A and the extended input signal in accordance with setting of the wavelength setting portion 200 to produce the second intermediate input signal. The fifth wavelength variable filter 211-2 multiplexes the second passing signal from the second wavelength variable filter 111-2 and the second intermediate input signal from the sixth wavelength variable filter 212 in accordance with setting of the wavelength setting portion 200 to produce the first intermediate input signal. The fourth wavelength variable filter 211-2 multiplexes the first passing signal from the first wavelength variable filter 111-1 and the first intermediate input signal from the fifth wavelength variable filter 211-2 in accordance with setting of the wavelength setting portion 200 to produce the output signal.

The wavelength setting portion 200 sets a wavelength of each wavelength variable filter in accordance with operation of an operator.

The third wavelength variable filter 112 produces the extended output signal having channels except for those of the first and the second passing signals and the dropped signal. Therefore, by connecting a set of a wavelength variable filter and an interleaver to the extended output port 110d of the first demultiplexing unit 110A, it is possible to extend a function of the optical add-drop apparatus. In a case of extending an addition side, it is possible to use the extended input signal supplied to the sixth wavelength variable filer 212.

Selection of add-drop channels in the optical add-drop apparatus according to the third embodiment of this invention may be carried out in similar manner in the optical add-drop apparatus illustrated in FIG. 7 in conjunction with FIGS. 11 and 12.

Inasmuch as the optical add-drop apparatus according to the third embodiment of this invention comprises two sets of wavelength variable filters for generating the passing signals and two paths for transmitting the passing signals, it is possible to make two wavelength bands the passing signals.

For instance, it will be assumed that the input signal has the first through the tenth channels. Under the circumstance, it is possible to make the third and the fourth channels the first passing signal, make the seventh and the eighth channels (i.e. channels which are not successive to those of the first passing signal) the second passing signal, make the first and the second channels the dropped signal, and make the fifth, the sixth, the ninth, and the tenth channels the extended output signal. In this manner, it is possible to select, as the passing signals, the channels which are not successive.

While this invention has thus far been described in conjunction with a few embodiments thereof, it will readily be possible for those skilled in the art to put this invention into practice in various other manners.

1. An optical add-drop apparatus for picking up, as a dropped signal, a signal having a particular wavelength from an input signal transmitted in a wavelength-multiplexed fashion and for adding an added signal to a passing signal to produce an output signal, said optical add-drop apparatus comprising:
a first demultiplexing unit having an input port for inputting said input signal, a through output port for outputting said passing signal, a drop port for outputting said dropped signal, and an extended output port for outputting an extended output signal, said first demultiplexing unit comprising a demultiplex main wavelength filtering portion for separating said input signal into said passing signal and an intermediate output signal and a demultiplex sub wavelength filtering portion for said intermediate output signal into said dropped signal and said extended output signal;
a second demultiplexing unit for separating said dropped signal into individual dropped channels;
a first multiplexing unit having a though input port for inputting said passing signal, an adding port for inputting said added signal, and an output port for outputting said output signal, said first multiplexing unit multiplexing said passing signal and said added signal to produce said output signal; and
a second multiplexing unit for multiplexing a plurality of addition channels to produce said added signal.

2. The optical add-drop apparatus as claimed in claim 1, wherein said demultiplex main wavelength filtering potion comprises a first demultiplex wavelength filter for separating said input signal into said passing signal and said intermediate output signal,
said demultiplex sub wavelength filtering portion comprising a second demultiplex filter for separating said intermediate output signal into said dropped signal and said expanded output signal.

3. The optical add-drop apparatus as claimed in claim 2, wherein each of said first and said second demultiplex filters comprises a wavelength variable filter.

4. The optical add-drop apparatus as claimed in claim 1, wherein said first multiplexing unit has, as said through output port, first and second through output ports for outputting said passing signal as first and second passing signals,
said demultiplex main wavelength filtering portion consisting of a first demultiplex wavelength filter for separating said input signal into said first passing signal and a first intermediate output signal and a second demultiplex wavelength filter for separating said first passing signal into said second passing signal and a second intermediate output signal,
said demultiplex sub wavelength filtering portion comprising a third demultiplex wavelength filter for said second intermediate output signal into said dropped signal and said expanded output signal.

5. The optical add-drop apparatus as claimed in claim 4, wherein each of said first through said third multiplex wavelength filters comprises a wavelength variable filter.

6. The optical add-drop apparatus as claimed in claim 1, wherein said second demultipexing unit comprises an interleaver.

7. The optical add-drop apparatus as claimed in claim 1, wherein said second demultiplexing unit comprises interleavers which are connected in a multistage fashion.

8. The optical add-drop apparatus as claimed in claim 1, wherein said second demultiplexing unit comprises a combination of a plurality of wavelength filters and a plurality of interleavers.

9. The optical add-drop apparatus as claimed in claim 1, wherein said second demultiplexing unit comprises a colorless AWG.

10. The optical add-drop apparatus as claimed in claim 1, wherein said first multiplexing unit further has an extended input port for inputting an extended input signal,
said first multiplexing unit comprising a multiplex sub wavelength filter portion for multiplexing said added signal and said extended input signal to produce an intermediate input signal and a multiplex main wavelength filter portion for multiplexing said passing signal and said intermediate input signal to produce said output signal.

11. The optical add-drop apparatus as claimed in claim 10, wherein said multiplex main wavelength filter portion comprises a first multiplex wavelength filter for multiplexing said passing signal and said intermediate input signal to produce said output signal,
said multiplex sub wavelength filter portion comprising a second multiplex wavelength filter for multiplexing said added signal and said extended input signal to produce said intermediate input signal.

12. The optical add-drop apparatus as claimed in claim 11, wherein each of said first and said second multiplex wavelength filters comprises a wavelength variable filter.

13. The optical add-drop apparatus as claimed in claim 10, wherein said first multiplexing unit has, as said passing input port, first and second through input ports for inputting first and second passing signals,
said multiplex main wavelength filter portion comprising a first multiplex wavelength filter for multiplexing said first passing signal and a first intermediate input signal to produce said output signal and a second multiplex wavelength filter for multiplexing said second passing signal and a second intermediate input signal to produce said first intermediate input signal,
said multiplex sub wavelength filter portion comprising a third multiplex wavelength filter for multiplexing said added signal and said extended input signal to produce said second intermediate input signal.

14. The optical add-drop apparatus as claimed in claim 13, wherein each of said first through said third multiplex wavelength filters comprises a wavelength variable filter.

15. The optical add-drop apparatus as claimed in claim 1, wherein said first multiplexing unit comprises a coupler.

16. The optical add-drop apparatus as claimed in claim 1, wherein said second multiplexing unit comprises a coupler.

17. The optical add-drop apparatus as claimed in claim 1, wherein said second multiplexing unit comprises an interleaver.

18. The optical add-drop apparatus as claimed in claim 1, wherein said second multiplexing unit comprises a plurality of interleavers which are connected in a multistage fashion.

19. The optical add-drop apparatus as claimed in claim 10, wherein said multiplex main wavelength filter portion comprises a first coupler for coupling said passing signal with said intermediate input signal to produce said output signal,
said multiplex sub wavelength filter portion comprising a second coupler for coupling said added signal with said extended input signal to produce said intermediate input signal.

20. A method of picking up, as a dropped signal, a signal having a particular wavelength from an input signal transmitted in a wavelength-multiplexed fashion and of adding an added signal to a passing signal to produce an output signal, said method comprising the steps of:
separating said input signal into said passing signal and an intermediate output signal;
separating said intermediate output signal into said dropped signal and an extended output signal;
separating said dropped signal into individual dropped channels;
multiplexing a plurality of addition channels to produce said added signal; and
multiplexing said passing signal and said added signal to produce said output signal.

21. A method of picking up, as a dropped signal, a signal having a particular wavelength from an input signal transmitted in a wavelength-multiplexed fashion and of adding an added signal to a passing signal to produce an output signal, said method comprising the steps of:
separating said input signal into said passing signal and an intermediate output signal;
separating said intermediate output signal into said dropped signal and an extended output signal;
separating said dropped signal into individual dropped channels;
multiplexing a plurality of addition channels to produce said added signal;
multiplexing said added signal and an extended input signal to produce an intermediate input signal; and
multiplexing said passing signal and said intermediate input signal to produce said output signal.
